(19) United States
(12) Patent Application Publication
(10) Pub. No.: US 2025/0385452 A1
(43) Pub. Date: Dec. 18, 2025

(54) PLUGGABLE RETIMER MODULE

(71) Applicant: Astera Labs, Inc., Santa Clara, CA (US)

(72) Inventors: Christopher Blackburn, Woodville, WA (US); Christian Markus Petersen, Golden, CO (US); Aanchal Sharma, Redwood City, CA (US); Casey Morrison, San Jose, CA (US); Jeffery Shu Chun Chang, San Jose, CA (US)

(21) Appl. No.: 19/233,227

(22) Filed: Jun. 10, 2025

Related U.S. Application Data
(60) Provisional application No. 63/660,252, filed on Jun. 14, 2024.

(51) Int. Cl. H01R 12/75; G06F 13/40; H01R 12/72; H01R 12/73

(52) U.S. Cl. CPC H01R 12/75; G06F 13/409; H01R 12/721; H01R 12/737; H01R 2201/06

(57) ABSTRACT

A small form-factor pluggable retimer module re-times signals transiting between its host-side plug-in connector and one or more passive-cable attach ports, extending the practicable signaling distance between cable-connected integrated circuit components without the costly motherboard/system-board re-design otherwise required to implement re-timing functions.

### CROSS REFERENCE TO RELATED APPLICATIONS

This application hereby claims priority to and incorporates by reference U.S. Provisional Application No. 63/660,252 filed Jun. 14, 2024.

### BRIEF DESCRIPTION OF THE DRAWING

The various embodiments disclosed herein are illustrated by way of example, and not by way of limitation, in the figures of the accompanying drawings and in which like reference numerals refer to similar elements and in which:

FIG. 1 illustrates exemplary deployment and implementation of a programmable retimer module (PRM) having a card-edge cable-emulation connector and a cable-attach port at adjacent edges of module substrate;

FIG. 2 illustrates various assembly options with respect to the programmable retimer module shown in FIG. 1;

FIG. 3 illustrates additional options with respect to cable-attach form-factor within the programmable retimer modules of FIGS. 1 and 2, showing alternative adjacent-edge embodiments and others;

FIG. 4 illustrates an exemplary mezzanine form-factor PRM;

FIG. 5 illustrates various pluggable retimer module embodiments having multiple cable-attach ports;

FIG. 6 illustrates a PRM embodiment having a protocol-converting retimer that splits a unified host-side link into two cable-side links;

FIG. 7 illustrates a PRM embodiment that implements a protocol conversion without link-split/link-merge—a unified-link protocol conversion that converts from a host-side protocol over the upstream link segment to a different cable-side protocol over the downstream link segment;

FIG. 8 illustrates exemplary applications of the protocol-converting PRM shown in FIG. 7;

FIG. 9 illustrates an exemplary application of a protocol-converting PRM to support endpoint redundancy; and

FIG. 10 presents an exemplary table listing (non-exhaustively) various options for pluggable retimer modules having card-edge-style cable-emulation connectors.

### DETAILED DESCRIPTION

In various embodiments herein, a small form-factor “pluggable retimer module” re-times signals transiting between its host-side plug-in connector and one or more passive-cable attach ports, extending the practicable signaling distance between cable-connected integrated circuit components (relative to passive cable alone) without the costly motherboard/system-board re-design otherwise required to implement re-timing functions. In a number of embodiments, the pluggable retimer module's host-side plug-in connector matches the physical form factor and electrical pin-out of a passive cable and thus constitutes (and is referred to herein as) a cable-emulation connector that may be inserted into a host-side (motherboard) cable-attach port otherwise intended to engage a passive cable. The pluggable retimer module's one or more cable-attach ports likewise match the form-factor/mapping of a passive-cable connector (though not necessarily the same cable-connector form factor of the cable-emulation connector) to enable attachment of one or more passive cables otherwise intended to engage motherboard connectors. A retimer IC (integrated circuit) coupled between the retimer module's cable-emulation connector and cable-attach port(s) to re-time signals transiting between those connectors and thereby extend the practicable signaling distance between cable-interconnected integrated circuit components—that is, between an IC mounted to the motherboard into which the retimer module is plugged and an IC disposed at a far end of a passive cable plugged into the retimer module's cable-attach port). In some implementations, described in further detail below, the pluggable retimer module includes multiple cable-attach ports that enable multiple cabled interconnects to a solitary host-side cable-attach port, with both cabled interconnects operating jointly (concurrently or simultaneously) or at alternate times. In those and other embodiments, the retimer IC may perform a protocol and/or signaling-rate conversion function, converting signals received from a host-side component (e.g., motherboard-mounted component) and destined for a remote component (at far end of passive cable) from one protocol/signaling-rate to another and vice-versa.

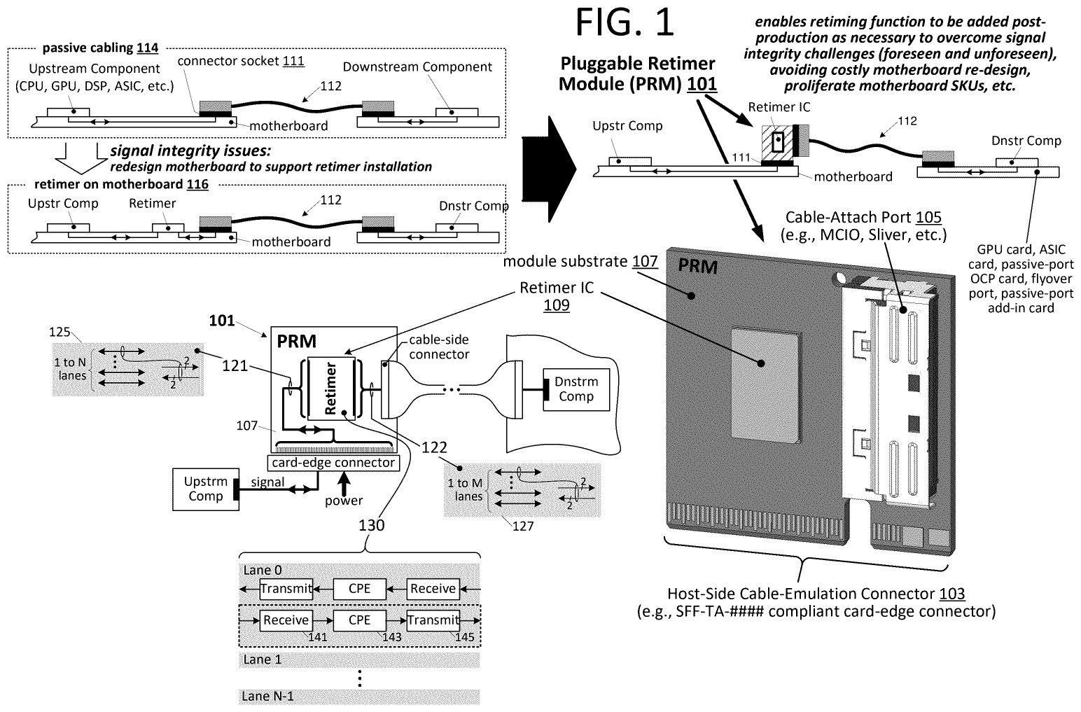

FIG. 1 illustrates exemplary deployment and implementation of a programmable retimer module 101 (PRM) having a card-edge cable-emulation connector 103 and a cable-attach port 105 at adjacent edges of module substrate 107. The PRM's cable-emulation connector 103 is plugged into a motherboard socket 111 otherwise intended to receive the terminal connector of a passive cable 112 (e.g., as shown in the passive cabling example at 114) with the cable connector instead inserted into the PRM's cable-attach port 105. A retimer IC 109, mounted on substrate 107 and coupled via respective sets of conductive traces to the emulation connector and cable-attach port (the substrate and conductive traces forming a printed circuit board (PCB)), retimes high-speed signals flowing in each direction between those interconnects (103, 105), for example, by sampling inbound signals to produce a digital data stream that propagates through the retimer IC (with optional content inspection/modification) to be retransmitted using a clean clock signal and thus with improved signal integrity (e.g., increasing signal-sampling amplitude and timing margins at the eventual signal destination)—enabling reliable high-speed communications over distances and/or at signaling rates otherwise impracticable without exceeding error-rate tolerances. Moreover, because the pluggable retimer module may be installed whenever and wherever needed, the pluggable module approach enables the retiming function to be added in the field (post-production) as necessary to overcome signal integrity challenges (foreseen or not), avoiding the costly motherboard re-design (and resulting increase in number of motherboard SKUs) that plague more conventional approach (e.g., redesigning motherboard to support retimer installation as shown at 116) and also enabling simple and cost-effective field serviceability (e.g., hot-swapping a new PRM for a suspect one within an operating installation).

Still referring to FIG. 1, conductive traces 121, 121 routed over the surface and/or hidden layers of PRM substrate 107 convey signals corresponding to one or more lanes of a high-speed signaling link (and optionally multiple high-speed signaling links) between the retimer IC and the adjacent-edge connector interfaces (i.e., cable-emulation connector 103 and cable-attach port 105). Retimer IC 109 synchronously samples inbound high-speed signals to produce a stream of symbols that are retransmitted (after optional content modification) in the destined direction using a clean clock—either recovered from the incoming data signals or self-generated (or both at respective times). While the retimer IC may operate with respect to any practicable protocol—including multiple protocols in protocol-converting PRM embodiments discussed below—the embodiment shown in FIG. 1 and others described below are compliant with one or more peripheral component interconnect express (PCIe) specifications and thus described in the terminology of those specifications. Accordingly, an upstream PCIe link segment having N bidirectional signaling lanes (each implemented by oppositely-directed differential conductor pairs and thus four conductors per lane as shown at 125) extends between an upstream “pseudo-port” of the retimer IC and an upstream integrated-circuit component such as a central processing unit (CPU), graphics processing unit (GPU), digital signal processor (DSP), ASIC, etc. (i.e., propagating to/from the upstream pseudo-port via the on-substrate traces, the cable-emulation connector and counterpart connector socket, and on-motherboard traces), while a downstream PCIe link segment having M bidirectional signaling lanes as shown in detail view 127 (where M may be but is not necessarily equal to N) extends between the downstream pseudo-port of the retimer IC and downstream integrated circuit component (propagating through the on-substrate traces, cable-attach port, passive cable, remote-board cable-attach port and remote-board signaling traces). As shown in detail view 130, retimer IC 109 includes signal receiver circuitry 141 (e.g., equalizing signal receiver with clock-data-recovery circuitry to recover data rate clock signal, media access control circuitry, deskew circuitry, domain-crossing circuitry, etc.), content-processing engine 143 (that may inspect and optionally modify content within inbound symbol stream, synthesize a replacement outbound symbol stream when inbound stream drops out, etc.) and signal transmitter circuitry 145 (retransmitting symbol stream using clean transmit clock instance) for each lane and flow direction (though circuitry may be provided to coordinate operations between lanes aggregated into a given signaling link, particularly for lane-to-lane deskew and other operations where timing and/or content of information flowing in one lane and/or direction may bear on another lane and/or direction). Also, while occasionally described herein as being constituents of the same link or link segment, upstream signaling lanes (and/or downstream signaling lanes) may be aggregated in any practicable manner to implement two or more signaling links, including configurations having fewer upstream links than downstream links (or vice-versa) as discussed below in the context of protocol conversion. In such disparate-link-count implementations, a given lane receiver 141 may be coupled via content-processing engine 143 to two or more signal transmitters 145 and vice-versa (i.e., in reverse direction two lane receivers 141 feed a single outbound transmitter 145). While the PCIe context is carried forward in various examples herein, any practicable alternative communications standard may be supported in all cases, including for example and without limitation, Ethernet, Infiniband, RapidIO, NVLink, etc. Also, in all embodiments, signals received in accordance with one communication standard may be re-transmitted in accordance with any other standard, thus implementing a cross-standard protocol conversion.

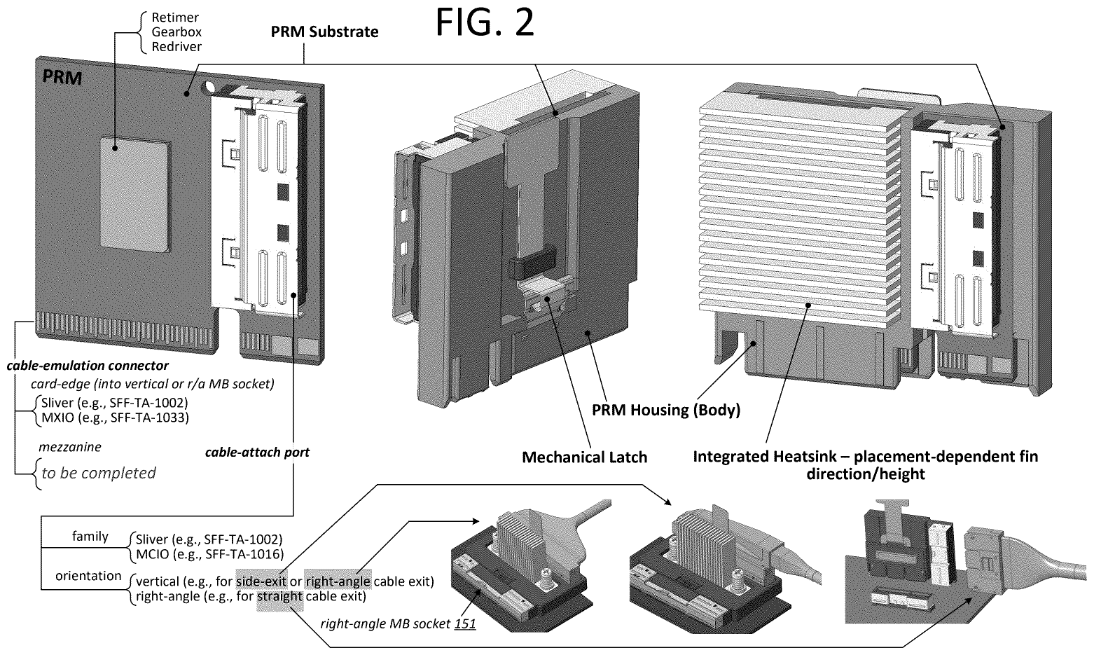

FIG. 2 illustrates various assembly options with respect to the programmable retimer module shown in FIG. 1, including for example and without limitation:
optional disposition of the PRM substrate in whole or part within a monolithic or multi-part housing (or enclosure or body), exposing the cable-emulation connector and cable-attach port to enable their engagement with counterpart connector socket and cable, respectively;
optional heatsink attachment (e.g., metal or other thermally conductive structure having, for example, any practicable fin height, orientation and/or pattern necessary to meet form-factor envelope and/or thermodynamic requirements) thermally coupled, for example, to the retimer IC to dissipate heat emanating from that chip;
various alternative cable-emulation connector form-factors, including card-edge connector to be inserted into a vertical or right-angle host printed circuit board connector socket (latter shown at 151), mezzanine connector socket, etc.
various alternative cable-attach port form-factors, including vertical connector ports to enable attachment of passive cables having right-angle or side-exit terminal connectors, right-angle connector ports to enable attachment of passive cables having straight-exit terminal connectors;
alternative dispositions of the cable-emulation connector and cable-attach ports relative to one another, including adjacent-edge disposition (i.e., cable-emulation connector and cable-attach port implemented/mounted on orthogonal/neighboring edges of quadrilateral substrate) and opposite-edge disposition (cable-emulation connector and cable-attach port on parallel/opposing edges of substrate); and
mechanical latch to engage detents and/or other structural features of the motherboard (or system-board) receptacle into which the cable-emulation connector is plugged, securing the connector within the receptacle and thus the PRM to the motherboard/system board (the cable-attach port may likewise include detents and/or other structural features to engage latching elements of a passive-cable connector and thereby secure the passive cable to the cable-attach port);

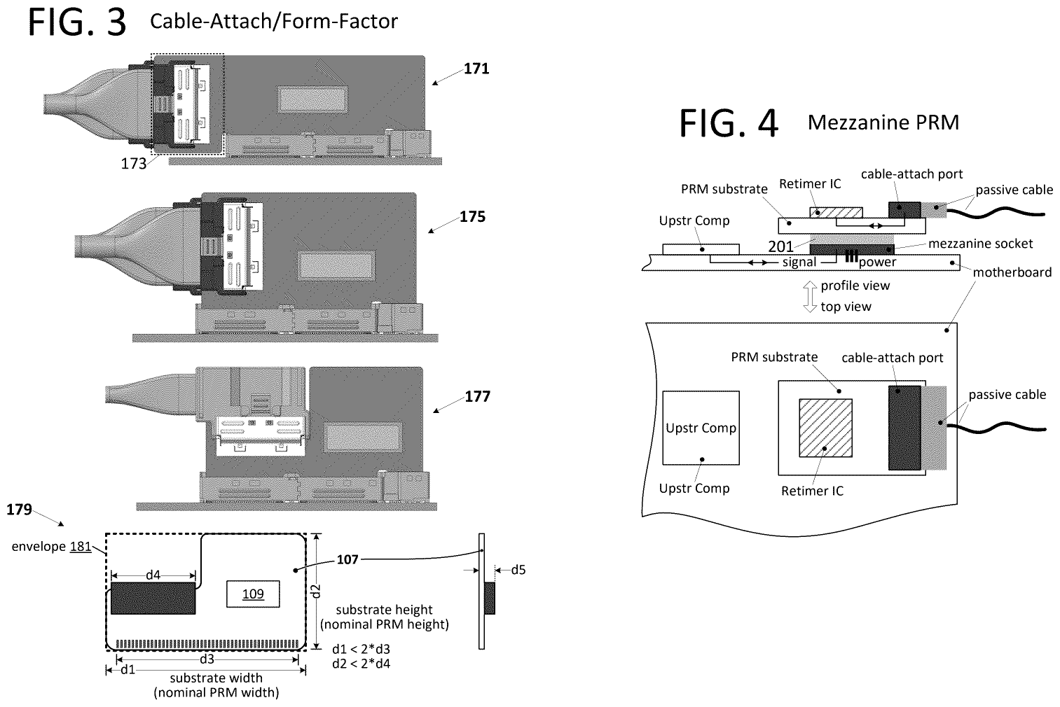

FIG. 3 illustrates additional options with respect to cable-attach form-factor within the programmable retimer modules of FIGS. 1 and 2, showing alternative adjacent-edge embodiments (cable-attach port mounted to PRM substrate edge adjacent to card-edge connector) including a low-height embodiment 171 in which the cable-attach port is mounted to a cantilevered section (173) of the PRM substrate (i.e., portion of the substrate that extends laterally beyond the cable-emulation connector in the direction of the cable exit) and a reduced-length embodiment 175 in which the cable-attach port is mounted above the cable-emulation connector. FIG. 3 also shows an opposite-edge PRM embodiment 177 having a corner-cutaway quadrilateral substrate with a cable-emulation connector implemented along the longest edge (bottom edge that plugs into the motherboard receptacle) and the cable-attach port mounted to a cutaway-exposed edge opposite the longest edge. In the depicted example, a side-exit cable is coupled to a right-angle cable-attach port (i.e., connector having contacts that extend vertically from the PRM substrate and then turn 90 degrees to engage counterpart contacts of the side-exit cable connector.

Still referring to FIG. 3, the PRM may be more generally viewed as having dimensions as shown at 179, having a substrate 107 characterized by a surface-area envelope 181—a conceptual quadrilateral or elliptical boundary with minimal width and height dimensions, d1 and d2, as necessary to surround the substrate—a cable-emulation connector with a width dimension d3 only marginally less than envelope width d1 (e.g., d3<2*d1, where ‘*’ denotes multiplication), and a cable-attach port having a width dimension d4 only marginally less than envelope height d2 (e.g., d4<2*d3). The PRM thickness (d5) nominally corresponds to the collective thickness of the substrate and components mounted or attached thereto (e.g., module thickness plus cable-attach port thickness as depicted in FIG. 3). In a specific example, the cable-emulation connector is implemented by a card-edge connector having a width less than twice the width of memory module substrate into which the PRM is to be plugged—and a cable-attach port having a width greater than half the height of the memory module substrate. In all cases, the total PRM height/width/thickness dimensions may extend to account for additional assembly components, including module housing, heat sink, etc.

FIG. 4 illustrates an exemplary mezzanine form-factor PRM—that is, a pluggable retimer module embodiment having a socket-style cable-emulation connector 201i (disposed on a face of the PRM substrate) to be inserted into a mezzanine socket disposed on the host circuit board (i.e., system board, main board, mother board, etc.). In the depicted example, the retimer IC and cable-attach port are mounted to the PRM substrate face opposite that of the cable-emulation connector and thus on top of the mezzanine surface of the PRM substrate (i.e., when PRM is plugged into motherboard socket, PRM substrate is disposed parallel to the motherboard).

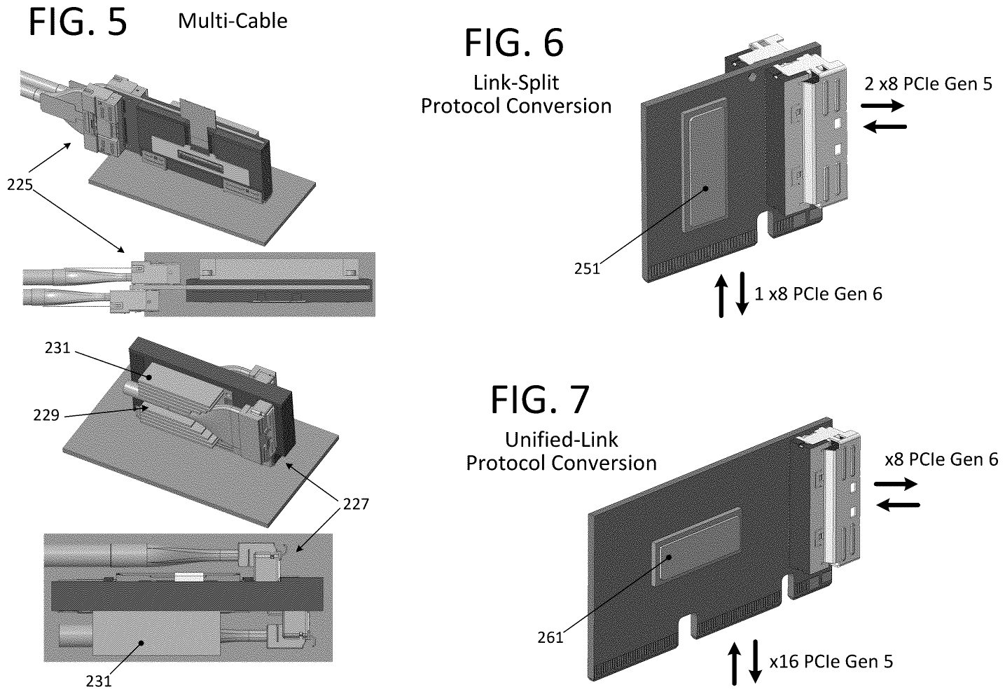

FIG. 5 illustrates pluggable retimer modules having multiple cable-attach ports-two in the depicted examples—to support various multi-cable configurations including, for example and without limitation:
re-timing of multiple signaling links: e.g., two or more links being retimed by one or more retimer ICs coupled between two or more cable-attach ports and respective, different sets of physical signaling conductors within a solitary cable-emulation connector (or between two or more cable-attach ports and two or more corresponding cable-emulation connectors);
multiplexed PRM cable-attach port designation: i.e., retiming between cable-emulation connector and a selected one of two or more cable-attach ports, with the cable-attach port selection being run-time multiplexed according to configuration setting, time-division multiplexed, etc.); and/or
link split/merge via protocol conversion: protocol/data-rate of communications traversing cable-emulation connector enabling twice (or N-times) the bandwidth of protocol/data-rate of communications through an individual one of two or more cable-attach ports with the collective bandwidth of the links conveyed via the multiple cable-attach ports nominally matching the bandwidth of the link conveyed via the cable-emulation connector.

Still referring to FIG. 5, dual cable-attach ports in an embodiment at ## are implemented by right-angle connectors mounted (e.g., soldered to landings, through-holes, etc.) on opposing sides of the PRM substrate, enabling attachment of straight-exit cable connectors as shown. In the embodiment shown at 227, two cable-attach ports are implemented by vertical connectors to enable side-exit cable attachment. In the depicted example, one of the side-exit cables passes through a shallow region 229 of heat sink 231 (i.e., having shortened fins in the shallow region). In other embodiments, vertical-connector cable-attach ports in the embodiment at 227 may be oriented for cable-egress in a direction opposite that shown (obviating fin-shortening in heat sink region 229) and, more generally, multi-cable-attach PRMs may be implemented with any viable connector type, quantity, orientation and placement-including PRMs having cable-emulation connectors intended for insertion in right-angle motherboard connectors or mezzanine-style sockets (so that, when plugged in to the motherboard connector, the PRM substrate orientation is parallel to the motherboard).

FIG. 6 illustrates a PRM embodiment having a protocol-converting retimer that splits a unified host-side link into two cable-side links—in the depicted example, splitting an 8-lane PCIe Generation-6 link (64 GT/s (giga transfers per second) per lane) into two 8-lane PCIe Generation-5 links (32 GT/s per lane) in the downstream direction (i.e., respectively traversing the two cable-attach ports) and, conversely, merging the two PCIe Gen 5 traffic streams into a unified PCIe Gen6 traffic stream in the upstream direction (i.e., toward the upstream component via the cable-emulation connector). In other link-split embodiments, a protocol converting PRM may split a single downstream link into two or more upstream links (splitting a traffic stream arriving via a single cable-attach port into two or more traffic streams outbound via the cable-emulation connector and, conversely, merging two or more traffic streams arriving via the cable-emulation connector into a single downstream link), protocols on either side of the link-split (in either direction) may be different from those shown (implementing any practicable conversion between protocols), and link-split ratio may be greater than 1:2 (e.g., 1:3, 1:4, 2:3, 2:4, etc.).

FIG. 7 illustrates a PRM embodiment that implements a protocol conversion without link-split/link-merge—a unified-link protocol conversion that converts from a host-side protocol over the upstream link segment (traversing cable-emulation connector) to a different cable-side protocol over the downstream link segment (traversing cable-attach port). In the depicted example, traffic is streamed in a sixteen-lane PCIe Gen5 link on the host side of protocol-converting retimer 261 and in an eight-lane PCIe Gen6 link on the cable-side of retimer 261—an arrangement that enables ˜50% wire-count reduction in the passive cable while maintaining the full host-side signaling bandwidth. Other embodiments may convert between different protocols and/or retime more than one signaling link (e.g., two x16 PCIe Gen5 host-side traffic streams converted to/generated from two x8 PCIe Gen6 cable-side traffic streams).

FIG. 8 illustrates exemplary applications of the protocol-converting (PC) PRM shown in FIG. 7, including:
protocol conversion at one end of a passive cable interconnect to match a pre-existing endpoint protocol, enabling PRM modules to be mixed/matched as necessary to fit a given system:
   in the example at 301, converting from host-side x16 PCIe Gen 5 to cable-side x8 PCIe Gen 6 to enable cabling from the PC PRM to a remote x8 PCIe Gen 6 passive-cable port,
   in the example at 303, converting from host-side x16 PCIe Gen 5 to cable-side x8 PCIe Gen 6 to enable cabling from the PC PRM to a remote non-protocol-converting (“protocol-adhering) PRM that retimes x8 PCIe Gen 6 traffic streams propagating in either direction-extending signaling reach and enabling protocol conversion via a single cabled interconnect; and
protocol conversion via PRMs at both ends of a cable interconnect, for example, to enable much thinner cables (reducing cable congestion, improve air flow, ease cable routing due to increased bend radius/smaller cable size, etc.)—converting, in the example shown at 321, from x16 PCIe Gen 5 on the endpoint side of each PRM (i.e., at respective cable-emulation connectors of the cable-connected PRMs) to x8 PCIe Gen 6 over the cabled interconnect, halving the wire count otherwise required within the cable.

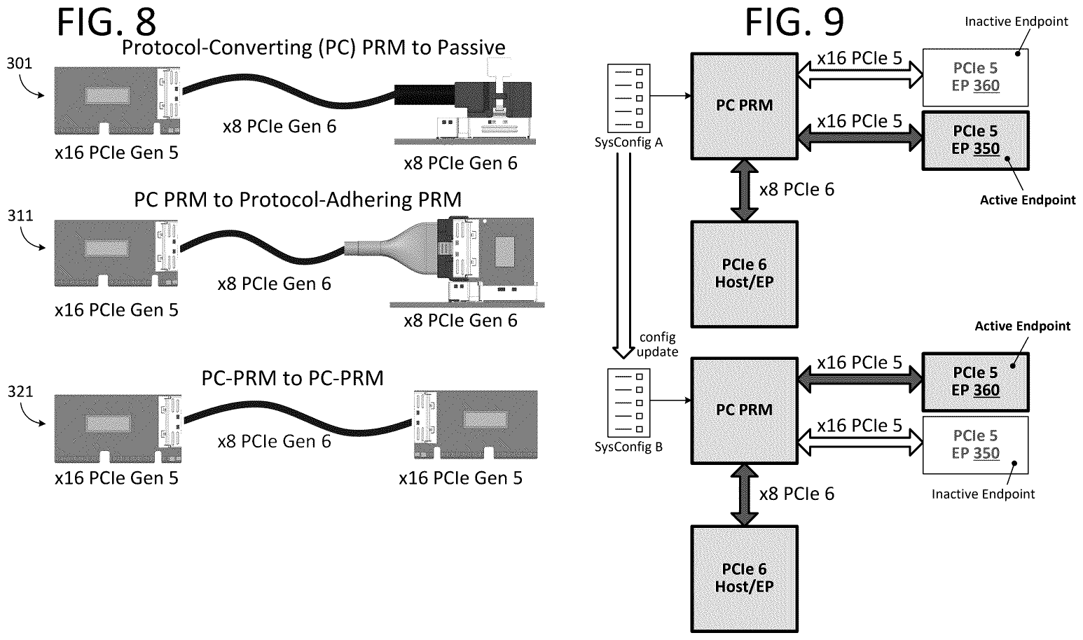

FIG. 9 illustrates an exemplary application of a protocol-converting PRM to support endpoint redundancy—retiming between a host-side link and a selected one of two endpoints under a first system configuration (endpoint 350 active, endpoint 360 inactive as indicated by system configuration A (SysConfig A)) followed by transition to a second system configuration in which the selection is flipped (endpoint 360 active, endpoint 350 inactive per SysConfig B). In the depicted example, the PC PRM converts between a x8 PCIe Gen6 host-side protocol and a x16 PCIe Gen5 cable-side protocol so that the full host-side bandwidth is allocated to the selected one of the endpoints (i.e., bandwidth match) in either system configuration. The transition from one active endpoint to the other (there may be more than two selectable endpoints) may be initiated by a human operator or automatically in response to determination that one or more switchover thresholds have been met (e.g., artificial intelligence, programmed processor, etc. evaluates whether various pre-set combinations of conditions have been met, executing switchover from one active endpoint to another upon affirmative determination) and implemented, for example, by programming/updating settings within one or more programmable registers within the PC PRM's retimer IC. While depicted in context of protocol conversion, a protocol-adhering PRM may also implement dynamic endpoint selection (e.g., x8 PCIe Gen6 at host-side PRM interface and on both end-point interfaces; x16 PCIe Gen5 at all PRM interfaces, host-side and both end-points; etc.).

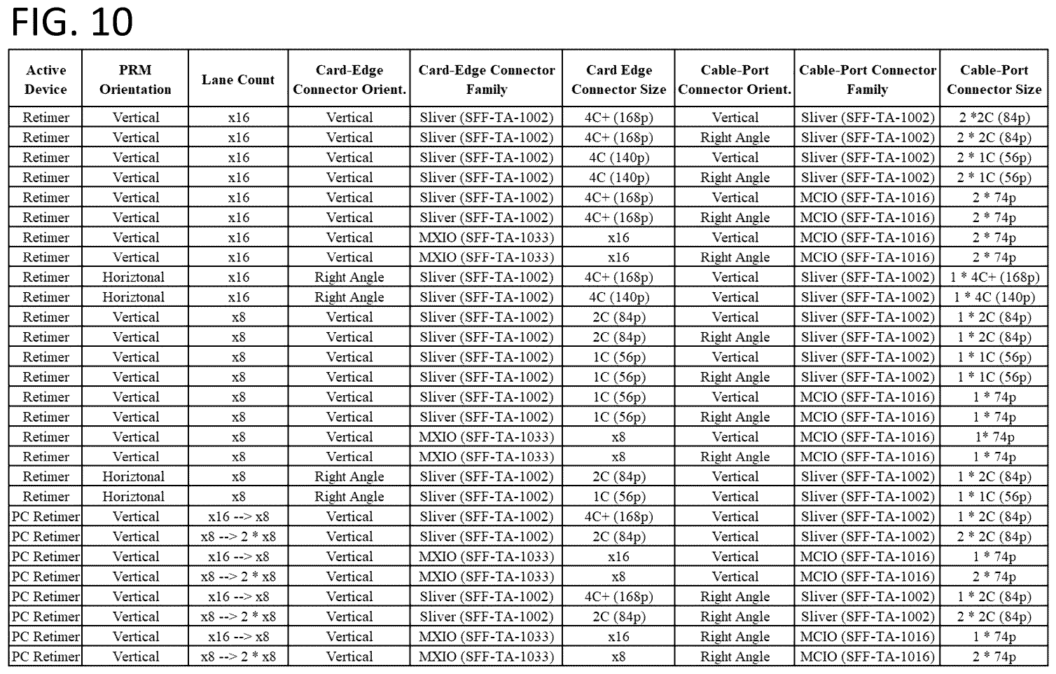

FIG. 10 presents an exemplary table listing (non-exhaustively) various options for pluggable retimer modules having card-edge-style cable-emulation connectors, including:
active component type: (protocol-adhering retimer (“retimer”) vs protocol converting retimer (“PC Retimer”)
PRM orientation: vertical (face of PRM substrate orthogonal to face of motherboard/system board) or horizontal (PRM substrate parallel to motherboard/system board as PRM slots into right-angle card-edge motherboard receptacle (e.g., as shown by right-angle MP socket 151 in FIG. 2).
lane count: number of host-side and cable-side signaling lanes, showing host-side to cable-side lane count transition (e.g., “x16→x8,” and “x8→2*x8,” the latter referring to multi-cable support with or without protocol conversion)
Card-Edge Connector Orientation: type of card-edge receptacle on motherboard/system board-right-angle (contacts extending from surface of motherboard/system board make a 90-degree turn to engage PRM card-edge connector) or vertical (contacts extend vertically from surface of motherboard/system board to engage PRM card-edge connector)
Card-Edge Connector Family: showing various small form factor committee technology-affiliate (SFF-TA) specifications, including specifications for Sliver and MXIO connectors;
Card-Edge Connector Size: showing various Sliver connector sizes (4C+, 4C, 2C, 1C and corresponding pin counts 168p, 140p, 84p and 46p) and MXIO connector sizes (x8, x16)
Cable-Port Connector Orientation: type of passive-cable receptacle on PRM—right-angle (contacts extending from surface of PRM substrate make a 90-degree turn to engage passive-cable connector) or vertical (contacts extend vertically from surface of PRM substrate to engage passive-cable connector);
Cable-Port Connector Family: showing various SFF-TA connector specifications, including specifications for Sliver and MCIO connectors; and
Cable-Port Connector Size: showing various Sliver connector sizes (4C+, 4C, 2C, 1C and corresponding pin counts 168p, 140p, 84p and 46p) and MCIO connector quantities/pin-counts

In the foregoing description and in the accompanying drawings, specific terminology and drawing symbols have been set forth to provide a thorough understanding of the disclosed embodiments. In some instances, the terminology and symbols may imply specific details not required to practice those embodiments. For example, the various programmable retimer module form factors (including connector and/or retimer placement), PRM components (e.g., substrate, housing, heatsink, host-side and/or cable-side physical-latching elements, etc.), PRM attachment orientations, connector types and orientations, connector quantities, pin-counts, applicable standards including connector form-factor/pin-count standards, signaling protocol standards, signaling-lane counts and so forth are provided for purposes of example only-any practicable alternatives may be implemented in all cases. Similarly, signaling link parameters, protocols, configurations may be implemented in accordance with any practicable open or proprietary standard and any version of such standard. Links or other interconnection between integrated circuit devices and/or PRM components may be shown as buses or as single signal lines. Each of the buses can alternatively be a single signal line (e.g., with digital or analog signals time-multiplexed thereon), and each of the single signal lines can alternatively be a bus. Signals and signaling links, however shown or described, can be single-ended or differential. Logic signals shown as having active-high assertion or “true” states, may have opposite assertion states in alternative implementations. A signal driving circuit is said to “output” a signal to a signal receiving circuit when the signal driving circuit asserts (or de-asserts, if explicitly stated or indicated by context) the signal on a signal line coupled between the signal driving and signal receiving circuits. The term “coupled” is used herein to express a direct connection as well as a connection through one or more intervening circuits or structures. Integrated circuit device or register “programming” can include, for example and without limitation, loading a control value into a configuration register or other storage circuit within the integrated circuit device in response to a host instruction (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operational aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. A retimer module comprising:
a substrate having a first width and first height;
a first connector disposed on a first edge of the substrate and having a physical form-factor and electrical pin-out that enables the retimer module to be plugged into a standard-compliant cable-connector receptacle mounted to a printed circuit board (PCB), the first connector having a second width less than twice the first width;
a second connector disposed on a second edge of the substrate and having a physical form-factor and electrical pin-out that enables a standard-compliant passive cable to be connected to the second connector; and
a retimer integrated circuit (IC) disposed on the substrate and electrically coupled between the first and second connectors, the retimer IC having circuitry to (i) generate a stream of digital symbols by synchronously sampling first signals arriving via either of the first and second connectors and (ii) output second signals corresponding to the stream of digital symbols from the retimer module via the other of the first and second connectors.

2. The retimer module of claim 1 wherein the second connector has a width greater than half the first height.

3. The retimer module of claim 1 wherein the standard-compliant cable-connector receptacle is form-factor and electrically compatible with the standard-compliant passive cable.

4. The retimer module of claim 1 wherein the standard-compliant cable-connector is mounted to a motherboard and electrically coupled to a processor also mounted to the motherboard.

5. The retimer module of claim 1 wherein the standard-compliant cable-connector receptacle and the standard-compliant passive cable are compliant with one or more Small Form Factor (SFF) Committee interoperability specifications.

6. The retimer module of claim 5 wherein the standard-compliant cable-connector receptacle is compliant with at least one of the following SFF Committee interoperability specifications: SFF-TA-1002, SFF-TA-1033.

7. The retimer module of claim 5 wherein the standard-compliant passive cable includes a terminal connector compliant with at least one of the following SFF Committee interoperability specifications: SFF-TA-1002, SFF-TA-1016.

8. The retimer module of claim 1 wherein the first signals convey first data in accordance with a first standard-compliant communication protocol and the second signals convey the first data in accordance with a second standard-compliant communication protocol that is different from the first standard-compliant communication protocol.

9. The retimer module of claim 1 wherein the first signals convey first data at a first data rate over a first quantity of signaling conductors coupled between the first connector and the retimer IC and the second signals convey the first data at a second data rate over a second quantity of signaling conductors coupled between the retimer IC and the second connector, the second data rate being either higher or lower than the first data rate and the second quantity of signaling conductors being conversely lower or higher than the first quantity of signaling conductors.

10. The retimer module of claim 9 wherein the second data rate is higher than the first data rate and the second quantity of signaling conductors is lower than the first quantity of signaling conductors.

11. The retimer module of claim 1 further comprising a third connector disposed on the substrate and electrically coupled to the retimer IC, the third connector having a physical form-factor and electrical pin-out identical to that of the second connector.

12. The retimer module of claim 11 wherein the circuitry within the retimer IC to output the second signals corresponding to the stream of digital symbols from the retimer module via the other if the first and second conductors comprises circuitry to output the second signals from the retimer module via the second connector after receiving the first signals via the first connector, the retimer IC further comprising circuitry to output third signals corresponding to the stream of digital symbols from the retimer module via the third connector.

13. The retimer module of claim 1 further comprising a housing that covers at least the retimer IC and a predominant portion of the substrate while exposing the first connector to enable its insertion into the standard-compliant cable-connector receptacle and exposing at least an opening of the second connector to enable the standard-compliant passive cable to be plugged into the second connector.

14. The retimer module of claim 1 further comprising a heat sink thermally coupled to the retimer IC to dissipate heat emanating therefrom.

15. The retimer module of claim 1 wherein the first connector comprises a card-edge connector.

16. The retimer module of claim 1 further comprising a mechanical latch to engage one or more structural features of the standard-compliant cable-connector receptacle in a manner that secures the first connector within the standard-compliant cable-connector receptacle.

17. The retimer module of claim 1 wherein the second connector comprises one or more structural elements to be engaged by a mechanical latching component of the standard-compliant passive cable.

18. The retimer module of claim 1 wherein the first and second connectors are disposed on adjacent, orthogonal edges of the substrate.

19. A method of operation within a run-time configurable retimer module having a substrate with a motherboard connector and cable connectors disposed thereon together with a retimer integrated circuit (IC) electrically coupled between the motherboard and cable connectors to retime signals conveyed therebetween, the method comprising:
generating a stream of digital symbols within the retimer IC by synchronously sampling first signals arriving at the retimer IC via the motherboard connector;
outputting, from the retimer IC, second signals corresponding to the stream of digital symbols exclusively to a first one of the cable connectors while the run-time configurable retimer module is configured in a first operating mode; and
outputting, from the retimer IC, second signals corresponding to the stream of digital symbols exclusively to a second one of the cable connectors while the run-time configurable retimer module is configured in a second operating mode.

20. The method of claim 19 further comprising transitioning from the first operating mode to the second operating mode in response to configuration information received via the motherboard connector.

21. The method of claim 20 wherein transitioning from the first operating mode to the second operating mode in response to configuration information received via the motherboard connector comprises receiving, within the retimer IC via the motherboard connector, an instruction to write a configuration value into a programmable register of the retimer IC.
